(19) United States
(12) Patent Application Publication
(10) Pub. No.: US 2019/0182356 A1
(43) Pub. Date: Jun. 13, 2019

(54) DATA NETWORKING METHOD IN DATA-CENTRIC NETWORK SYSTEM AND APPARATUS IMPLEMENTING SAME

(71) Applicant: ELECTRONICS AND TELECOMMUNICATIONS RESEARCH INSTITUTE, Daejeon (KR)

(72) Inventors: Nam Seok KO, Daejeon (KR); Sung Hyuk BYUN, Daejeon (KR); Sun Me KIM, Daejeon (KR)

(21) Appl. No.: 16/210,196

(22) Filed: Dec. 5, 2018

(30) Foreign Application Priority Data
Dec. 8, 2017 (KR) 10-2017-0168717

(51) Int. Cl. H04L 29/06; H04L 29/08; H04L 12/743; H04L 12/725; H04W 4/20

(52) U.S. Cl. CPC H04L 67/42; H04L 67/26; H04W 4/20; H04L 45/306; H04L 45/7453

(57) ABSTRACT

The present invention relates generally to a network system. Particularly, the present invention relates to a networking method of performing functional data processing in a data-centric network system in which both a pull mode and a push mode are supported. In a data networking method in a data-centric network system of the present invention, a message containing context meta information is received, the received context meta information is analyzed, and from the result from the analysis, filtering for each function element used in a context filtering table (CFT) is performed. Also, function processing specified for a content including the filtered function element is performed.

### CROSS REFERENCE TO RELATED APPLICATION

The present application claims priority to Korean Patent Application No. 10-2017-0168717, filed Dec. 8, 2017, the entire content of which is incorporated herein for all purposes by this reference.

### BACKGROUND OF THE INVENTION

### 1. Field of the Invention

The present invention relates generally to a network system. Particularly, the present invention relates to a networking method of performing functional data processing in a data-centric network system in which both a pull mode and a push mode are supported. Also, the present invention relates to a network system including a user terminal and a network node to perform the functional data processing.

### 2. Description of Related Art

Recently, the era of ultra-connection has come, in which everything is connected. According to market research institutions, it is expected that more than several tens of billions of things are connected in 2020. Also, by 2020, the amount of data is expected to increase exponentially every year, and it is thus heralded that we have entered the era of ultra-connection data.

However, if such a large amount of data is not efficiently managed, the value that may be derived from the data is not properly generated and it only takes up storage capacity.

Recently, various types of network technology research has been carried out to change the basic paradigm of networking and make data use efficient. In this regard, there is an information-centric networking method based on a pull mode in which required data is requested and fetched, for example, Named Data Networking (NDN) or information-centric networking (ICN). Also, there is a data publisher and subscriber-based networking method, such as Pursuit, in which when data is produced, the data is pushed to a network and to a user who requested the data.

Also, rather than in terms of simple data transfer, a Named Function Networking (NFN) method, which extends the concept of ICN, in which a data processing function for processing data is named and the processing required for data is specified before the data is actually fetched, has also proposed.

However, NFN also includes only the functional processing by the data requestor that requires data. Accordingly, a network protocol, in which the functional processing is included when a data producer publishes and provides data, and the user terminal supporting the same have not yet been proposed.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a new network system and a data networking method and apparatus using the same.

Also, the present invention is intended to propose a network system and a network essential configuration apparatus in which both data transfer methods in a pull mode and a push mode are supported and depending on the needs of a data producer, it is possible to request data processing.

Also, the present invention is intended to propose a network system and a network essential configuration apparatus in which sovereignty of the data producer is ensured by performing data type and content processing and data access right control according to intent of the data producer.

Also, the present invention is intended to propose a user terminal and a node device that constitute a network system for achieving the above purposes.

Other objects and advantages of the present invention will be understood from the following descriptions and become apparent by the embodiments of the present invention. Also, it is understood that the objects and advantages of the present invention may be implemented by components defined in the appended claims or their combinations.

In order to achieve the above object, according to one aspect of the present invention, there is provided a data networking method in a data-centric network system, the method including: receiving a message containing a content function name and context meta information corresponding to function processing; performing filtering for each function element used in a content filtering table (CFT) by analyzing the context meta information; and performing the function processing specified for a content including the filtered function element.

Furthermore, the message may be at least one among a request message, a response message, a subscription message, and a publication message.

Furthermore, the request message, the subscription message, and the publication message may include content function name fields.

Furthermore, the publication message may include the content required to be published and function processing context information for the content.

Furthermore, the context meta information may be produced by a content producer that requests publication function processing.

In order to achieve the above object, according to another aspect of the present invention, there is provided a data network system including: a host terminal producing and transmitting a message containing a content function name and context meta information corresponding to function processing; a first node transmitting the message to a node that is capable of performing the function processing of a content required by the host terminal, from the message received from the host terminal; and a second node, on the basis of the function name and the context meta information, performing filtering for each function element and performing the function processing specified for the content including a filtered function element, after receiving the message from the first node or the host terminal.

Furthermore, the message produced by the host terminal may be at least one among a request message, a response message, a subscription message, and a publication message.

Furthermore, the request message, the subscription message, and the publication message may include content function name fields for the function processing.

Furthermore, the publication message may include the content required to be published and function processing context meta information for the content.

Furthermore, the context meta information may be produced by a content producer that requests publication function processing.

Furthermore, the second node may include a content processing unit that includes at least one function processing processor performing a content function processing operation.

Furthermore, the second node may further include: an interface receiving and transmitting the message and the content over a network; and a storage means for storing data or the content.

Furthermore, the second mode may further include a context filtering table (CFT) analyzing and filtering the function name and the context meta information.

Furthermore, the content filtering table (CFT) may be a table for each function requested by a content filtering pointer.

Furthermore, the second mode may further include a pending request table (PRT) including the context filtering pointer.

In order to achieve the above object, according to still another aspect of the present invention, there is provided a user terminal for a host in a data-centric network system, the user terminal including: a content production unit producing a content function name and context meta information corresponding to function processing according to a purpose of a content; a message processing unit producing a message appropriate for a format of a message type, which contains the content function name and the context meta information; and a communication unit transmitting the produced message over a network.

Furthermore, when the message type is a publication message, the context meta information for the function processing of a content producer may be included.

Furthermore, the user terminal may further include: a memory temporarily storing the content; and a user interface receiving a user command.

According to the embodiments of the present invention, both data transfer methods in the pull mode and the push mode are supported, and an appropriate data transfer method is possibly selected according to the characteristics of the application.

Also, depending on the needs of the data requester or the data user, it is possible to request function processing on the data, and the data producer can specify the processing function for the data even when publishing the data, whereby sovereignty of the data producer is ensured.

Also, data function processing of the data producer and requester or the user is possible through the network, so that the utilization value of a large amount of data that is present in the network may be further increased.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a diagram illustrating an example of a configuration of a data-centric network system applied to the present invention;

FIGS. 2A and 2B are diagrams illustrating examples of a hierarchical naming method of a network data applied to the present invention;

FIGS. 3 to 6 are diagrams illustrating examples of four types of network data messages and information included in each message applied to the present invention;

FIG. 7 is a diagram illustrating an example of a detailed configuration of a user terminal of a data-centric network system according to the present invention;

FIG. 8 is a diagram illustrating an example of a detailed configuration of a designated DCN node (DDN) of a data-centric network system according to the present invention;

FIG. 9 is a diagram illustrating data input and output at the designated DCN node (DDN) of a data-centric network system according to the present invention;

FIG. 10 is a flowchart illustrating a process by the content request message in the data-centric network system of the present invention; and

FIG. 11 is a flowchart illustrating a process by the content publication message in the data-centric network system of the present invention.

### DETAILED DESCRIPTION OF THE INVENTION

Hereinafter, exemplary embodiments of the present invention will be described in detail with reference to the accompanying drawings such that the present invention can be easily embodied by those skilled in the art to which this present invention belongs. However, the present invention may be embodied in various different forms and should not be limited to the embodiments set forth herein.

In describing the embodiments of the present invention, if it is decided that the detailed description of known function or configuration related to the invention makes the subject matter of the invention unclear, the detailed description is omitted. Also, parts that are not related to the description of the present invention are omitted in the drawings, and like reference numerals designate like parts.

In the present invention, constituent elements that are distinguished from each other to clearly describe each feature do not necessarily denote that the constituent elements are separated. That is, a plurality of constituent elements may be integrated into one hardware or software unit, or one constituent element may be distributed into a plurality of hardware or software units. Accordingly, even if not mentioned, the integrated or distributed embodiments are included in the scope of the present invention.

In the present invention, constituent elements described in various embodiments do not denote essential elements, and some of the elements may be optional. Accordingly, an embodiment that includes a subset of constituent elements described in another embodiment is included in the scope of the present invention. Also, an embodiment that includes the constituent elements which are described in the various embodiments and additional other elements is also included in the scope of the present invention.

If necessary, data is used with a mix of content to describe the present invention, but these are just different expressions of the same object and technical meanings are not different. For example, “data” may be an expression of physical or objective meaning, and “content” may be an expression of subjective meaning.

Hereinafter, embodiments of the present invention will be described with reference to the accompanying drawings.

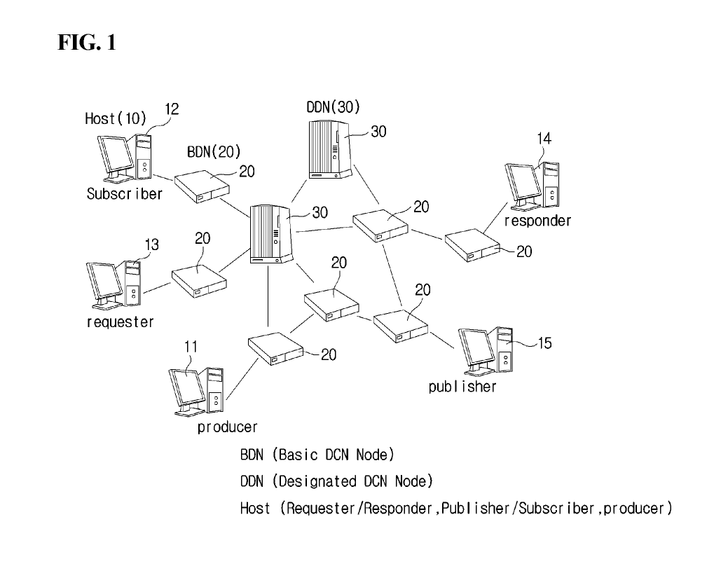

FIG. 1 is a diagram illustrating an example of a configuration of a data-centric network system applied to the present invention.

The data-centric network (hereinafter, referred to as “a DCN”) according to the present invention has a structure in which data transfer methods in a pull mode and a push mode both are supported. That is, for example, like named data networking (NDN), the structure in which a network data transfer method that an interest packet for the content is transmitted and the content is received in response thereto and a publisher and subscriber based network data transfer method are applied simultaneously are described.

Also, according to the present invention, unlike the conventional ICN method in which data is received by requesting data processing depending on the needs of the content data user, the processing function for the data is specified when the data consumer makes a request and when the data producer publishes the data, so that processing of the data type, content, and the like, data access right control are performed according to intent of the data producer, thereby sovereignty of the data producer is ensured.

Referring to FIG. 1, the DCN according to the present invention includes, a DCN participating host 10, which is the subject of content producing or content consuming, and two types of DCN nodes 20 and 30.

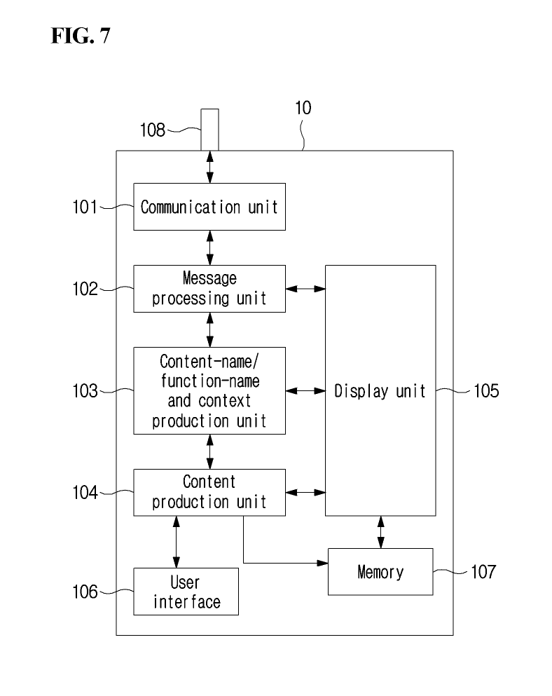

The host 10 may be a data producer 11 that produces data, a data subscriber 12 that requests regular subscription or use of data, a data requester 13 that request specific data for data use, a data responder 14 that responds to the data request, and a data publisher 15 that performs publication and open of the produced data. However, the host 10 is arbitrarily divided according to a function, and it is possible that multiple functions or all functions are performed by a single terminal. In general, the host 10 may be referred to as a user terminal, and this will be described in detail with reference to FIG. 7.

A first node of the DCN nodes is a basic data node (BDN) 20 that receives the DCN message transmitted from the host 10 and is in charge of content publication and, storage or caching in the DCN. The BDN is also referred to as a first DCN node or a basic DCN, and corresponds to the modification of the DCN node used in the conventional data network.

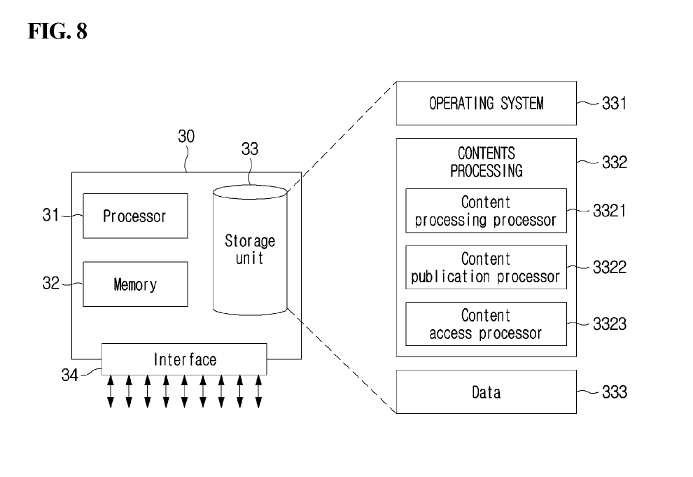

A second node of the DCN nodes is a designated data node (DDN) 30 that is capable of performing processing such as data processing in response to the request from the BDN or the data producer 11, publishing agent, content access control, and the like. The DDN is also referred to as a second DCN node or a special DCN node, and the DDN performs the function processing to achieve the purpose of the present invention. Hereinafter, configuration and operation of the DDN will be described in detail with reference to FIGS. 8 to 11.

In this regard, the DDN 30 may be present at an arbitrary location within the DCN, but in general, it is desirable that the BDN 20 is provided between the host 10 and the DDN 30 so as to reduce the load of the DDN in structure. However, the present invention is not limited thereto, and depending in the intention of the network system designer, it is possible to allow direct access to the DDN 30 from the host 10, or to prevent the DDN having the same function from being duplicated, or to provide the DDN 30 at the optimum location within the network system by considering the location of the content producer 11, publisher 15, subscriber 12, or requester 13 as the host 10 and the performance of the DDN 30.

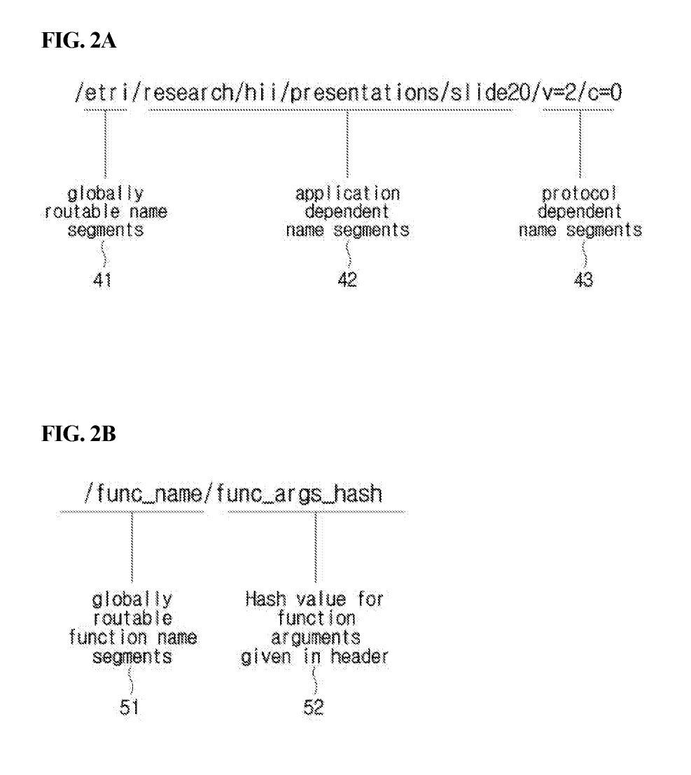

FIGS. 2A and 2B are diagrams illustrating examples of a hierarchical naming method of a network data applied to the present invention. In the DCN according to the present invention, the content and the function are named and the content request and response based on the name are processed.

Also, regarding the name given to the content and the function, a public key hash value of the name owner is included in the name so that a flat address having a self-certifying ID without intervention of the trusted third party is given.

The present invention uses, for example, a hierarchical content name structure as shown in FIG. 2A. The hierarchical content name structure of the data may be, for example, configured as “/etri/research/presentations/slide20/v=2/c=0”. In the name, the head “etri” 41 means a communication router address to which data is transmitted and is used as a globally common address. Also, “research/presentations/slide20/” 42 means a lower-layer application address within the relevant router address (“etri” 41) and means the location where actual data is present. Also, “v=2/c=0” 43 means protocol information for data communication.

Also, for example, the present invention may use a hierarchical function name structure shown in FIG. 2B. The hierarchical function name structure of the data may be, for example, configured as “/func_name/func_args_hash”. That is, the names of the functions as shown in FIG. 2B includes: a globally routable function name 51 itself, and a hash 52 of information included in the meta information, such as a name of the host which requests the function, a session number within the host, and the like. It is possible to distinguish the same function request from multiple hosts or from other sessions of the same host.

Specifically, in the name, the head “/func_name” 51 means the name of the function to which the data is subjected. For example, functions such as data processing, publication, access control, and the like may be performed. These functions are managed as a network system standard, and the rule determined as a standard may be applied to each network participant, such as, the host 10, the BDN 20, and the DDN 30. For example, the rule may be determined in a manner that “0001” is assigned as the function type for the processing function, “0010” is assigned as the function type for the publication function, and “0100” is assigned as the function type for the access control function.

Also, the tail “/func_args_hash” 52 of the hierarchical function name structure of the data is given as a hash value of the relevant function, which is also included in the header information.

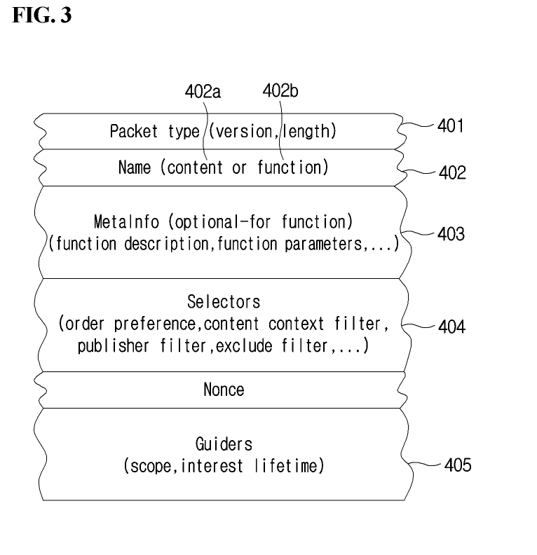

FIGS. 3 to 6 are diagrams illustrating examples of four types of network data messages and information included in each message applied to the present invention.

The DCN according to the present invention provides, as described in FIGS. 3 to 6, four types of packets for transmitting and receiving the content. A first type is a content request message for requesting the content. A second type is a content subscription message for indicating intent to receive the content at a point in time when the content is available regardless of whether or that the actual data is currently present. A third type is a content response message corresponding to the content request message. A fourth type is a publication message for publishing the content to the user who has already requested subscription to the content or who will request it at a point in time in the future.

FIG. 3 is a diagram illustrating an example of a configuration of the content request message for requesting the content. Referring to FIG. 3, the content request message includes: a packet type field 401 indicating a message packet type (including at least a message version and a message size); a content name field 402 defining either a content name 402a or a function name 402b as a content name; and a meta information field 403 containing meta information on the content function processing. Also, the content request message may further include a selection field 404 defining user selections for the requested content and a guide field 405. For example, in the content name field 402, the function name of the function of “content request” is set, and in the relevant meta information field 403, the detailed processing function for the requested content is described, such that content transmission corresponding to the request from the content requester is possible.

In this regard, the content name 402a or the function name 402b defined in the content name field 402 may be expressed by the content name or the function name of the hierarchical structure as described above with reference to FIG. 2. However, the present invention is not limited thereto, and is applicable to various methods of expressing the content name or the function name.

Also, the meta information field 403 includes context information of the content having the name other than the basic name (for example, the content name 402a or the function name 402b) in the content name field 402. For example, the meta information field 403 may include, as context meta information related to the content requested to be subscribed, a function description, function parameters, and the like.

Here, the context means the content that is assigned differently depending on the temporal, spatial situations of elements, such as the data producer, the data consumer, the network node, and the like, which may affect production and consumption of data. The context information is used in indicating the content function when requesting the content and in filtering and selecting the relevant content. This context enables the content requester, subscriber, or publisher to explicitly specify the content when requesting the content in such a manner that contents of the same name having different contexts may be selectively received according to the context.

Also, when generating and publishing the content, a content provider (the content publisher targets the responder to the content request or an arbitrary subscriber) makes the context information of the relevant content to be included in such a manner that the content matching with the desired context is transmitted to the content receiver.

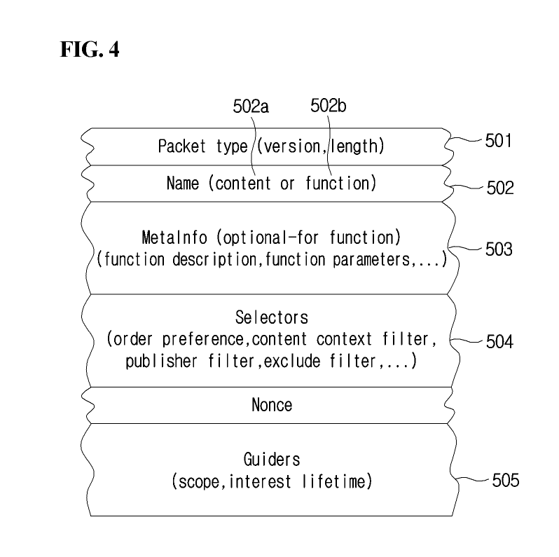

FIG. 4 is a diagram illustrating an example of a configuration of the subscription message for indicating intent to receive the content at a point in time when the content is available regardless of whether or that the actual data is currently present. Referring to FIG. 4, the content subscription message includes: a packet type field 501 indicating at least a message packet type (including at least a message version and a message size); a content name field 502 defining either a content name 502a or a function name 502b as a content name; and a meta information field 503 containing meta information on the content function processing. Also, the content request message may further include a selection field 504 defining user selections for the requested content and a guide field 505. For example, in the content name field 502, the function name of the function of “content subscription” is set, and in the relevant meta information field 503, the detailed processing function for the requested content is described, such that content transmission corresponding to the request from the content subscriber is possible.

Regarding the subscription message, in addition to the message for subscription, a message type for canceling the subscription may be defined as a sub type. The sub-type message may be referred to as “a subscription cancellation message” to be distinguished from the subscription message.

For example, the meta information field 503 may include, as the context meta information related to the content requested to be subscribed, a function description, function parameters, and the like.

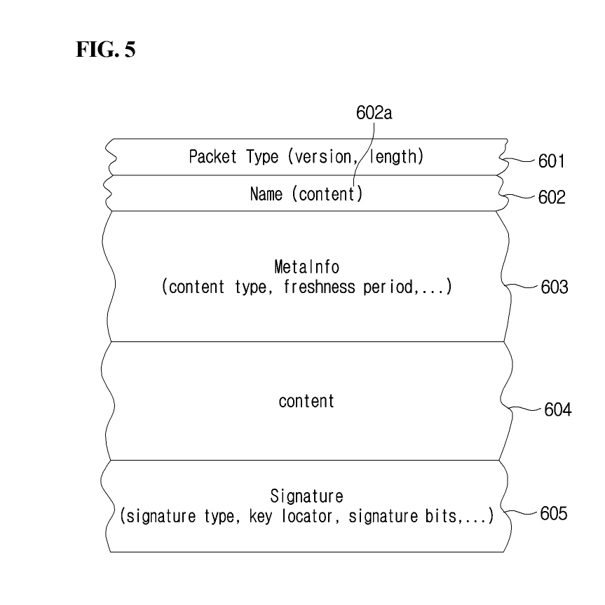

FIG. 5 is a diagram illustrating an example of a configuration of the content response message corresponding to the content request message shown in FIG. 3. Referring to FIG. 5, the content response message includes: a packet type field 601 indicating a message packet type (including at least a message version and a message size); a content name field 602 indicating the requested content name; and a meta information field 603 containing meta information on the content function processing.

Also, the content response message may include a content 604 transmitted in response to the requested content and may further include signature information 605 of the content transmitter. In this regard, in the content name field 602, only the provided content name is indicated and the function name is not indicated. Also, the meta information field 603 may include, as the context meta information related to the provided content 604, for example, the content type, the content production period, and the like.

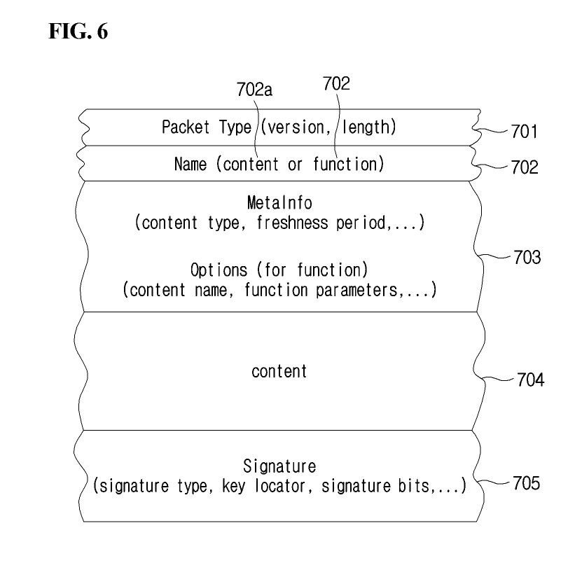

FIG. 6 is a diagram illustrating an example of a configuration of a publication message for publishing the content to the user who has already requested subscription to the content or who will request it at a point in time in the future. Referring to FIG. 6, the content publication message includes: a packet type field 701 indicating a message packet type (including at least a message version and a message size); a content name field 702 defining either a content name 702a or a function name 702b as a content name; and a meta information field 703 containing meta information on the content function processing. For example, in the content name field 702, the function name of the function of “content publication” is set, and in the relevant meta information field 703, the detailed processing function for the content required to be published is described, such that content publication corresponding to the request from the content publisher is possible.

Also, the content publication message may include the content 704 requested to be published and may further include signature information 705 of the content publisher.

In this regard, the meta information field 703 may include, as context meta information related to the content 704 requested to be published, for example, the content type, the content production period, and the like. Also, optionally, the meta information field 703 may further include, for efficient publication function processing, the content name, function parameters, and the like.

In this regard, according to the present invention, among the messages shown in FIGS. 3 to 6, all the messages except for the response message shown in FIG. 4 transmitted in response to the request message shown in FIG. 3 are designated by “the function names”, which specifies the function processing for the content, rather than the content names, and the messages are directly transmitted to the DDN 30 that may process the function. Here, the function processing means all packet processing operations using the content, which include security function processing, such as processing for the content, and the filtering function for access control to the content.

FIG. 7 is a diagram illustrating an example of a detailed configuration of the user terminal 10 for the host of the data-centric network system according to the present invention. As described above, the user terminal 10 means a terminal that performs at least one of the functions of the hosts 11, 12, 13, 14, and 15 in FIG. 1 on the DCN of the present invention.

Referring to FIG. 7, the user terminal 10 includes a content production unit 104, a content-name/function-name and context production unit 103, a message processing unit 102, and a communication unit 101. Also, the user terminal 10 includes a display unit 105 for displaying content production, content name and context information production, and message processing. Also, the user terminal 10 may further include a memory 107 for temporarily storing the data and the content and a user interface 106 for receiving a user command. Also, the user terminal 10 may further include an RF module 108 having an antenna that communicates with the outside in cooperation with the communication unit 101.

In this regard, when it is desired to transmit the message, the content-name/function-name or context production unit 103 produces the name and context information appropriate for the messages types shown in FIGS. 3 to 6, and the message processing unit 102 finally produces the message appropriate for the message type format shown in FIGS. 3 to 6 and transmits the final message to the communication unit 101. Here, in the case of “the response message shown in FIG. 5” or “the publication message shown in FIG. 6” which includes the content, it is possible to directly produce the content by the content production unit 104 or to use the content stored in the memory 107.

In contrast, when receiving the message, the message received via the communication unit 101 is subjected to process appropriate to the purpose of the received message by the message processing unit 102.

FIG. 8 is a diagram illustrating an example of a detailed configuration of the designated DCN node (DDN) 30 or the second node of a data-centric network system according to the present invention.

Referring to FIG. 8, the DDN 30 includes: an interface 34 performing data communication with the outside; and a storage unit 33 storing a program for the operation of the DDN 30. Also, the DDN 30 may further include: a processor 31 performing efficient calculation and control within the node; and a memory 32 temporarily storing the data.

In this regard, communication schemes for the interface 34 include, for example, the Internet, wireless data communication, near field mobile communication Wi-Fi, and the like. Also, the interface 34 may include multiple interface ports or faces with respect to the same communication scheme. Each port or face of the interface is individually managed.

Also, the storage unit 33 includes: an operating system 331 having an overall operating system program for the DDN 30 thereon; a storage means 333 for storing data or contents; and a content processing unit 332 having multiple processors performing content function processing operations. Here, the multiple processors for processing the content functions include a content processing processor 3321, a content publication processor 3322, and a content access processor 3323. However, it is obvious that there may be various function processing processors for processing functions of the present invention other than the above processors.

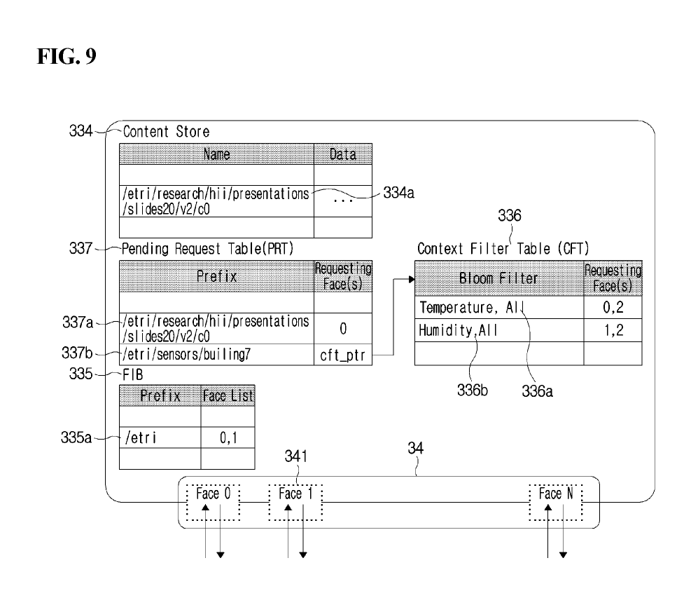

Hereinafter, a data or content function processing method using the DDN 30 will be described in detail with reference to FIGS. 9 to 11.

FIG. 9 is a diagram illustrating data input and output at the designated DCN node (DDN) of a data-centric network system according to the present invention. Particularly, FIG. 9 shows a content forwarding structure according to the present invention. In this regard, the content forwarding structure shown in FIG. 9 will be described mainly about the DDN 30, and it is possible to configure the same structure in the BDN 20 except for the function processing process.

Referring to FIG. 9, according to the present invention, the packet forwarding of the DCN uses a stateful forwarding method.

For example, the process of processing the case in which the content consumer transmits the request message shown in FIG. 3 or the subscription message shown in FIG. 4 with the name of the content or of the processing function required for the content will be described.

The DDN 30 (or the BDN 20) that received the request message shown in FIG. 3 or the subscription message shown in FIG. 4 stores the interface to which the relevant corresponding message is input and checks whether the content corresponding to the relevant name is stored in a content storage 334.

When the content is present in the content storage 334, the packet is forwarded to an input interface. However, when the desired content is not present in the content storage 334, a record 337a of the request based on the name is stored in a pending request table (PRT) 337 and the request message shown in FIG. 3 or the subscription message shown in FIG. 6 is forwarded with a forwarding information base (FIB) 335 operation. However, when the DDN 30 that received the message is appropriate for the content function processing, it is obvious that direct processing is performed without forwarding to other network nodes. The detailed function processing method of the DDN 30 will be described later.

When the request message or the subscription message is transmitted from another network, the content is transmitted along the path through which the request message or the subscription message is transmitted according to the PRT 337 of each node. Also, the transmitted content (for example, the reference numeral 334a) performs content caching in the convent storage 334 in such a manner than when the same content request is made in the future, the relevant node directly transmits the content.

In this regard, in the PRT 337, the request message, such as an interest in a request-response type communication model, and the subscription message for a publication-subscription (pub/sub) service are considered. That is, for example, regarding the PRT entry 337a produced by the request message, when the requested content arrives and is forwarded, the relevant interface is deleted from the PRT entry. However, the subscription message is not deleted from the PRT until the subscription cancellation message arrives.

Also, only the input interface is stored with respect to the conventional content name. However, in the present invention, forwarding is filtered according to the context regardless of the same name in such a manner to consider the context with respect to the content having the same name. That is, for example, when the context for the content is included in the meta information field 403 or 503 of the request message or subscription message, the PRT 337 does not store the input interface for the content name and stores the field 337b indicating that context filtering is required with a point (cftptr) for the entry of the filtering table.

Accordingly, in the entries 336a and 336b of the relevant filtering table within the context filtering table (CFT) 336, the input interface (requesting face) into which the request message or subscription message is input with the context as a key is stored.

When the input request message or subscription message is configured with the function name, the final destination of the relevant message is the particular DDN 30 capable of processing the function. If the DDN which has received the request message or subscription message first is capable of performing the relevant function processing, it performs the function processing by itself.

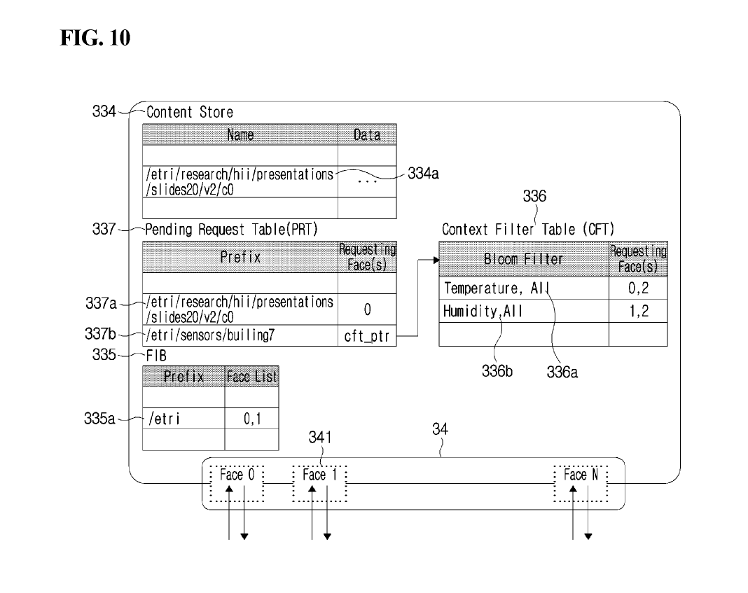

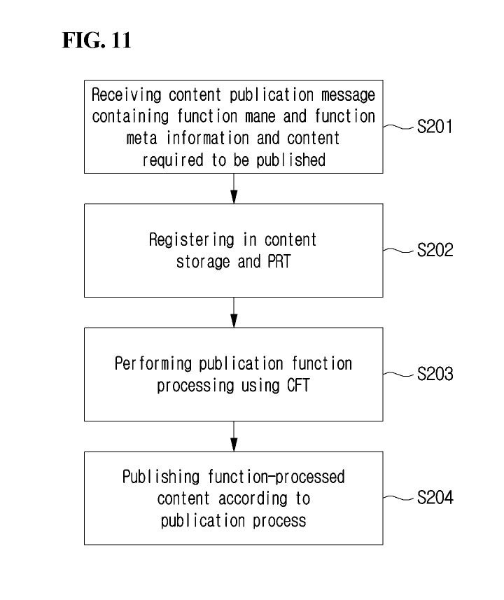

Hereinafter, with reference to FIGS. 10 and 11, the content function processing flowcharts using the DDN 30 will be described as follows.

FIG. 10 is a flowchart illustrating a process by the content request message in the data-centric network system of the present invention.

First, from the host (for example, the data requester 13) requesting the content, the request message shown in FIG. 3 is received at step S101. The request message includes, as described above, the meta information for the function name and the function processing. In this case, the name of the request message is designated by the function name, and additional information (parameter information for the function processing, which includes the content name) for the function processing is included as the meta information.

It is checked whether the content related to the request message shown in FIG. 3 is present locally within the DDN 30 at step S102. When the relevant content is present locally within the DDN 30 that received the message, the content is read from the content storage 334 and is registered in the PRT 337. After, filtering for the function processing according to the CFT 336 is performed.

When the relevant content is not present locally, the request message for the relevant content is transmitted to another node at step S104, and then the content is received from another node at step S105, and the function processing is performed and forwarding is performed according to the PRT.

The content filtered through the CFT is subjected to the final function processing using any one of the function processing processors in the content processing unit 332 shown in FIG. 8 at step S106. After, the final function-processed content is transmitted to the content requester at step S107.

FIG. 11 is a flowchart illustrating a process by the content publication message in the data-centric network system of the present invention. First, from the host (for example, the data publisher 15) requesting content publication, the publication message shown in FIG. 5 is received at step S201. The publication message includes, as described above, the meta information for the function name and the function processing. In this case, the name of the publication message is designated by the function name, and additional information (the parameter information for the function processing, which includes the content name) for the function processing is included as the meta information.

The content for publication, which is included in the received publication message is stored in the content storage 334 and is registered in the PRT 337. After, content filtering for the function processing according to the CFT 336 is performed at step S202.

After, the DDN 30 which received the publication message obtains function related information in the meta information included within the message and performs the function processing, and then the publication processor 3322 within the content processing unit 332 shown in FIG. 8 is used to perform the final function processing at step 203. After, the final function-processed content is published according to intent of the content publisher at step S204.

In this regard, the content filtering process using the PRT 337 and the CFT 336 will be descried as follows, for example. The content filtering table (CFT) 336 shown in FIG. 9 is a table that is present individually for each entry of the PRT 337 which requires context filtering. Also, each CFT includes each piece of context information, for example, a bloom filter for each function element.

As described above, the context may be explicitly specified or may be dynamically determined according to the situation. As an embodiment of the present invention, assuming that the context is explicitly given, for example, two hosts, a host A and a host B, use “/etri/building7/sensors” 337b as the subscription message for the content. In this regard, classification into one context is possible, but different types of function elements (for example, sensor information) may be requested. For example, the host A may request either the temperature or the humidity as a function element, and the host B may request both the temperature and the humidity as function elements. The CFT distinguishes the function element to be filtered from the context information and uses it for content filtering. In the above example, the case in which the context information explicitly requested by each of the hosts A and B via the meta information field is transmitted has been described. However, as another embodiment, it is possible to determine the context using situation information independently recognized outside the host.

As described above, in the present invention, for configuring the new data-centric network system, the format for each message type, an operation in the user terminal, and an operation in the DDN have been described. The above-described method according to the present invention may be realized as a program and stored in a computer-readable form in a recording medium (for example, a CD-ROM, a RAM, a ROM, a floppy disk, a hard disk, a magneto-optical disk, and the like). Since such processes can be easily embodied by those skilled in the art to which the present invention belongs, the detailed description thereof will be omitted.

Various substitutions, modifications, and changes from the spirit of the present invention defined in the following claims by those skilled in the art are also included in the scope of the present invention, so that the present invention described above is not limited to the embodiments and the accompanying drawings.

What is claimed is:

1. A data networking method in a data-centric network system, the data networking method comprising:
receiving a message containing a content function name and context meta information corresponding to function processing;
performing filtering for each function element used in a content filtering table (CFT) by analyzing the context meta information; and
Performing the function processing specified for a content including the filtered function element.

2. The data networking method of claim 1, wherein the message is at least one among a request message, a response message, a subscription message, and a publication message.

3. The data networking method of claim 2, wherein the request message, the subscription message, and the publication message comprise content function name fields.

4. The data networking method of claim 2, wherein the publication message comprises the content required to be published and function processing context meta information for the content.

5. The data networking method of claim 4, wherein the context meta information is produced by a content producer that requests publication function processing.

6. The data networking method of claim 1, wherein the content filtering table (CFT) is a table for each function requested by a content filtering pointer.

7. A data network system comprising, as elements constituting a data-centric network system:
a host terminal producing and transmitting a message containing a content function name and context meta information corresponding to function processing;
a first node transmitting the message to a node that is capable of performing the function processing of a content required by the host terminal, from the message received from the host terminal; and
a second node, on the basis of the function name and the context meta information, performing filtering for each function element and performing the function processing specified for the content including a filtered function element, after receiving the message from the first node or the host terminal.

8. The data network system of claim 7, wherein the message produced by the host terminal is at least one among a request message, a response message, a subscription message, and a publication message.

9. The data network system of claim 8, wherein the request message, the subscription message, and the publication message comprise content function name fields for the function processing.

10. The data network system of claim 8, wherein the publication message comprises the content required to be published and function processing context information for the content.

11. The data network system of claim 10, wherein the context meta information is produced by a content producer that requests publication function processing.

12. The data network system of claim 7, wherein the second node comprises a content processing unit that includes at least one function processing processor performing a content function processing operation.

13. The data network system of claim 12, wherein the second node further comprises:
an interface receiving and transmitting the message and the content over a network; and
a storage means for storing data or the content.

14. The data network system of claim 12, wherein the second mode further comprises a context filtering table (CFT) analyzing and filtering the function name and the context meta information.

15. The data network system of claim 14, wherein the context filtering table (CFT) is a table for each function requested by a context filtering pointer.

16. The data network system of claim 15, wherein the second mode further comprises a pending request table (PRT) including the context filtering pointer.

17. A user terminal for a host in a data-centric network system, the user terminal comprising:
a content production unit producing a content function name and context meta information corresponding to function processing according to a purpose of a content;
a message processing unit producing a message appropriate for a format of a message type, which contains the content function name and the context meta information; and
a communication unit transmitting the produced message over a network.

18. The user terminal of claim 17, wherein when the message type is a publication message, the context meta information for the function processing of a content producer is included.

19. The user terminal of claim 17, further comprising:
a memory temporarily storing the content; and
a user interface receiving a user command.
